(19) United States
(12) Patent Application Publication
(10) Pub. No.: US 2025/0100546 A1
(43) Pub. Date: Mar. 27, 2025

(54) AUTOMATIC PARKING SYSTEM

(71) Applicants: TOYOTA JIDOSHA KABUSHIKI KAISHA, Toyota-shi (JP); AISIN CORPORATION, Kariya-shi (JP)

(72) Inventors: Koichiro YAMAUCHI, Tokyo (JP); Takuya SAKATA, Tokyo (JP); Tsuyoshi KUBOYAMA, Kariya-shi (JP)

(73) Assignees: TOYOTA JIDOSHA KABUSHIKI KAISHA, Toyota-shi (JP); AISIN CORPORATION, Kariya-shi (JP)

(21) Appl. No.: 18/779,228

(22) Filed: Jul. 22, 2024

(30) Foreign Application Priority Data
Sep. 21, 2023 (JP) 2023-155652

(51) Int. Cl. B60W 30/06; B60W 50/10; B60W 50/14

(52) U.S. Cl. CPC B60W 30/06; B60W 50/10; B60W 50/14; B60W 2050/146

(57) ABSTRACT

An automatic parking system includes a line-of-sight detection unit configured to detect a line-of-sight angle of a driver, a visual recognition determination unit configured to determine whether the driver has visually recognized a region requiring visual recognition around a vehicle, a notification unit configured to provide notification when the region requiring visual recognition is not visually recognized, and a correction unit configured to correct the line-of-sight angle that has been detected. The correction unit corrects the line-of-sight angle based on a reference line-of-sight angle determined based on a display position of a start button and the line-of-sight angle detected by the line-of-sight detection unit when the driver operates the start button.

### CROSS-REFERENCE TO RELATED APPLICATIONS

This application is based upon and claims the benefit of priority from Japanese Patent Application No. 2023-155652, filed On Sep. 21, 2023, the entire contents of which are incorporated herein by reference.

### BACKGROUND

### Field

The present disclosure relates to an automatic parking system.

### Description of the Related Art

For example, Japanese Unexamined Patent Publication No. 2021-154843 discloses an automatic parking system for a vehicle to automatically park itself. This automatic parking system recognizes an obstacle around the vehicle with an external sensor and causes the vehicle to park itself in a parking area while avoiding the obstacle.

Here, in the automatic parking system, it is desirable that the driver visually checks the surroundings of the vehicle so that the driver can immediately perform an override operation during the automatic parking control. For this purpose, the automatic parking system detects the line-of-sight angle of the driver from an image captured by a driver monitor camera. Then, when the driver is not visually recognizing the surroundings of the vehicle during automatic parking, the automatic parking system notifies the driver to visually recognize the surroundings of the vehicle.

### SUMMARY

There may be an error in the detection of the line-of-sight angle of the driver. For example, there is a difference in the detection accuracy of the line-of-sight angle depending on whether glasses are worn, an opening state of the eyes, and the like for individuals. For this reason, for example, even though the driver is looking forward through the windshield, it may be determined that the driver is not visually recognizing the surroundings of the vehicle, and a notification may be issued to visually recognize the surroundings of the vehicle.

Thus, the present disclosure describes an automatic parking system capable of more accurately detecting a line-of-sight angle of a driver and appropriately encouraging the driver to visually check the surroundings of a vehicle during automatic parking.

An automatic parking system of the present disclosure is [1] “an automatic parking system configured to perform automatic parking of a vehicle when a start button for instructing start of automatic parking is operated by a driver, the system including a display control unit configured to display the start button on a display screen of a touch panel, a line-of-sight detection unit configured to detect a line-of-sight angle of the driver, a visual recognition determination unit configured to determine whether a region requiring visual recognition around the vehicle is visually recognized after the automatic parking is started based on the line-of-sight angle detected by the line-of-sight detection unit, a notification unit configured to provide notification when the visual recognition determination unit determines that the region requiring visual recognition is not visually recognized, and a correction unit configured to correct the line-of-sight angle detected by the line-of-sight detection unit based on a reference line-of-sight angle determined based on a display position of the start button and the line-of-sight angle detected by the line-of-sight detection unit when the driver operates the start button on the display screen, wherein the visual recognition determination unit is configured to perform the determination using the line-of-sight angle that has been corrected when the line-of-sight angle is corrected by the correction unit”.

The automatic parking system of the present disclosure may be [2] “the automatic parking system according to [1] wherein the visual recognition determination unit is configured to acquire a traveling direction of the vehicle in the automatic parking and set the region requiring visual recognition such that a region on the traveling direction side that has been acquired is included”. The automatic parking system of the present disclosure may be [3] “the automatic parking system according to [1] or [2], wherein the visual recognition determination unit is configured to determine that the region requiring visual recognition is visually recognized when the region requiring visual recognition has been visually recognized continuously for a predetermined time or more after the automatic parking is started”.

The automatic parking system of the present disclosure may be [4] “the automatic parking system according to any one of [1] to [3], wherein the display control unit is configured to display the start button at a position different from a previous position on the display screen”. The automatic parking system of the present disclosure may be [5] “the automatic parking system according to any one of [1] to [4], the system further including a head detection unit configured to detect a head position of the driver, wherein the correction unit is configured to estimate a line-of-sight angle when the start button is visually recognized from the head position detected by the head detection unit and use the line-of-sight angle that has been estimated as the reference line-of-sight angle”.

According to one aspect of the present disclosure, it is possible to more accurately detect the line-of-sight angle of the driver and appropriately encouraging the driver to visually check the surroundings of the vehicle during automatic parking.

### BRIEF DESCRIPTION OF THE DRAWINGS

FIG. 1 is a block diagram illustrating an overall configuration of an automatic parking system according to an embodiment;

FIG. 2A is a diagram illustrating an example of a display screen on which a start button is displayed;

FIG. 2B is a diagram illustrating an example of a display screen on which a start button is displayed; and

FIG. 3 is a flowchart illustrating a flow of processing when the automatic parking system performs automatic parking of a vehicle.

### DETAILED DESCRIPTION

Hereinafter, an exemplary embodiment will be described with reference to the drawings. In the drawings, the same or corresponding elements are denoted by the same reference numerals, and redundant description will be omitted.

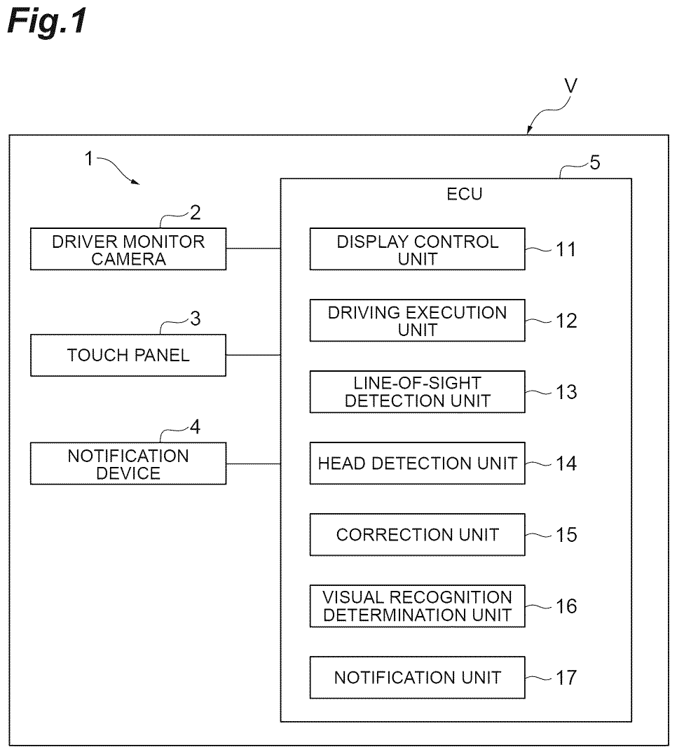

As illustrated in FIG. 1, an automatic parking system 1 is mounted on a vehicle V that can travel automatically. Here, the vehicle V can perform automatic parking for automatically parking itself in a parking frame as automated driving. The automatic parking system 1 performs automatic parking of the vehicle V when a start button for instructing start of automatic parking is operated by a driver.

The automatic parking system 1 also detects a line-of-sight angle of the driver. After starting automatic parking, the automatic parking system 1 determines whether the driver is visually recognizing the surroundings of the vehicle based on the detected line-of-sight angle. When the driver is not visually recognizing the surroundings of the vehicle V, the automatic parking system 1 notifies the driver to visually recognize the surroundings of the vehicle V.

The automatic parking system 1 includes a driver monitor camera 2, a touch panel 3, a notification device 4, and an electronic control unit (ECU) 5. The driver monitor camera 2 captures an image of the driver of the vehicle V. The driver monitor camera 2 is installed on, for example, an instrument panel or a ceiling portion in front of the driver's seat, so that the camera can capture an image of the face of the driver.

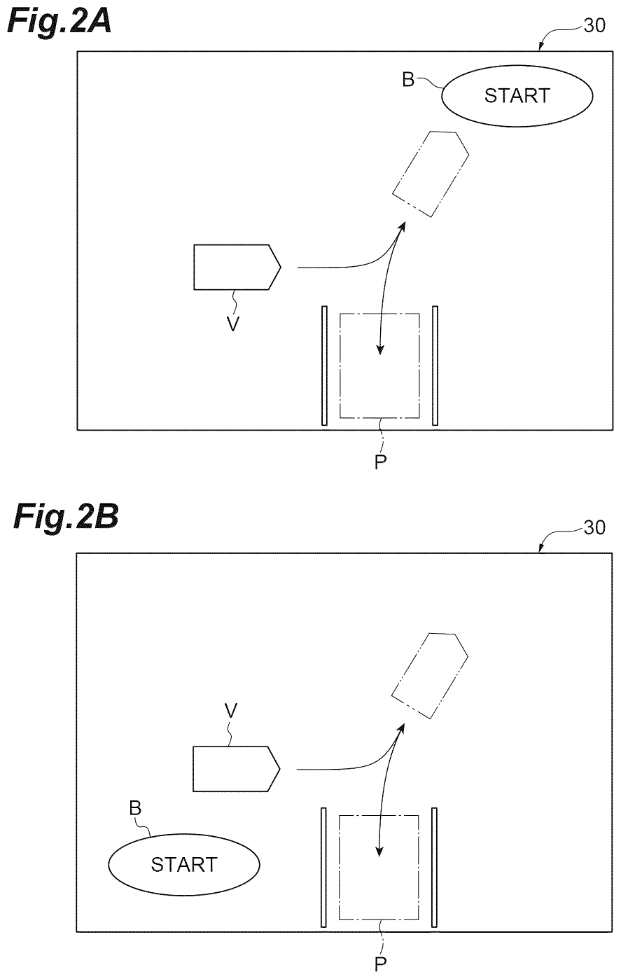

The touch panel 3 is a device that receives information display and input operation. The touch panel 3 includes a display screen 30 (see FIGS. 2A and 2B) for displaying information. When the driver touches the display screen 30, the touch panel 3 can detect the touch position touched by the driver on the display screen 30. The touch panel 3 may also serve as a display unit of a navigation system. The notification device 4 is a device that provides notification to the driver. The notification device 4 may include at least one of a speaker, a display screen, a lamp, and the like. The display screen 30 of the touch panel 3 may also serve as the notification device 4.

The ECU 5 is an electronic control unit having a central processing unit (CPU), a read only memory (ROM), a random access memory (RAM), and the like. The ECU 5 implements various functions, for example, by loading a program recorded in the ROM into the RAM and executing the program loaded into the RAM with the CPU. The ECU 5 may include a plurality of electronic units. The ECU 5 functionally includes a display control unit 11, a driving execution unit 12, a line-of-sight detection unit 13, a head detection unit 14, a correction unit 15, a visual recognition determination unit 16, and a notification unit 17.

The display control unit 11 controls an image to be displayed on the display screen 30 of the notification device 4. Here, as illustrated in FIG. 2A, the display control unit 11 displays a start button B on the display screen 30. The start button B is a button for the driver to instruct the start of execution of automatic parking of the vehicle V. FIG. 2A is an image diagram illustrating a state in which the vehicle V is viewed from above. For example, the display control unit 11 displays the start button B when automatic parking can be executed after the driver instructs to activate the automatic parking system 1. For example, the display control unit 11 may display the start button B when a parking position P where the vehicle V is to be parked is recognized and the vehicle V can be parked at the parking position P. The driver can issue an instruction to activate the automatic parking system 1 by operating an activation button installed in a navigation system or the like, for example.

As illustrated in FIG. 2A and FIG. 2B, the display control unit 11 displays the start button B at a position different from the previous position on the display screen 30. That is, the display control unit 11 displays the start button B at a different position every time the driver instructs to activate the automatic parking system 1.

When the start button B is operated by the driver, the driving execution unit 12 executes automatic parking of the vehicle V so that the vehicle V is parked at the parking position P. The driving execution unit 12 controls traveling of the vehicle V by instructing an actuator that controls traveling of the vehicle V.

The line-of-sight detection unit 13 detects the line-of-sight angle of the driver based on the detection result of the driver monitor camera 2. The line-of-sight angle indicates the direction of the line of sight of the driver. The line-of-sight detection unit 13 can detect the line-of-sight angle of the driver based on a known method using the detection result of the driver monitor camera 2. For example, the line-of-sight detection unit 13 may set the average value of the distribution of the line-of-sight angles within a certain period as the line-of-sight angle of the driver.

The head detection unit 14 detects the head position of the driver. The head detection unit 14 detects the head position of the driver based on the detection result of the driver monitor camera 2 and based on a known image processing technique or the like.

The correction unit 15 corrects the line-of-sight angle of the driver detected by the line-of-sight detection unit 13. Here, an error may occur in the line-of-sight angle detected by the line-of-sight detection unit 13. In addition, it is known that an error in detection of the line-of-sight angle varies for each driver depending on how the driver's eyes are open and whether the driver wears glasses. The correction unit 15 corrects such an error in detection of the line-of-sight angle that occurs for each driver.

When the driver operates the start button B, it is necessary to pay close attention to the start button B in order to confirm the display position of the start button B. Thus, the line-of-sight angle detected by the line-of-sight detection unit 13 when the driver operates the start button B originally faces the start button B. When an error occurs here, this error can be said to be an error in detection of the line-of-sight angle that occurs for each driver. The correction unit 15 corrects the line-of-sight angle detected by the line-of-sight detection unit 13 based on the line-of-sight angle when the driver operates the start button B on the display screen 30.

Specifically, the correction unit 15 corrects the line-of-sight angle detected by the line-of-sight detection unit 13 based on a predetermined reference line-of-sight angle and a line-of-sight angle detected by the line-of-sight detection unit 13 when the driver operates the start button B. The reference line-of-sight angle is determined in advance based on the display position of the start button B. The reference line-of-sight angle is a line-of-sight angle on a design when the driver looks at the start button B. The reference line-of-sight angle is a line-of-sight angle on a design when the start button B is viewed from a position where the head of the driver is estimated to be present. For example, the correction unit 15 offsets the line-of-sight angle detected by the line-of-sight detection unit 13 by a difference between the reference line-of-sight angle and the line-of-sight angle detected by the line-of-sight detection unit 13 as the correction of the line-of-sight angle.

The correction unit 15 may use a reference line-of-sight angle set based on a virtual head position of the driver. The correction unit 15 is not limited to this configuration, and the correction unit 15 may estimate the line-of-sight angle when the start button B is visually recognized from the position of the head detected by the head detection unit 14, and use the estimated line-of-sight angle as the reference line-of-sight angle. In this case, the correction unit 15 can use a more accurate reference line-of-sight angle in consideration of the height or the like of the driver.

Further, the correction unit 15 may use, as the line-of-sight angle detected by the line-of-sight detection unit 13 when the driver operates the start button B, the line-of-sight angle extracted based on the time-series change in the line-of-sight angle among the line-of-sight angles detected by the line-of-sight detection unit 13. For example, when the driver operates the start button B, the line of sight of the driver moves from the surroundings of the vehicle V to the display screen 30, and then moves to the surroundings of the vehicle V. That is, when such a change in the line-of-sight angle of the driver occurs, it can be said that the driver has visually recognized the start button B on the display screen 30. Thus, the correction unit 15 can extract the line-of-sight angle at the time when the driver is looking at the display screen 30 (start button B) based on the time-series change in the line-of-sight angle, and perform correction using the extracted line-of-sight angle.

The correction unit 15 corrects the detected line-of-sight angle when the line-of-sight angle detected by the line-of-sight detection unit 13 deviates from the reference line-of-sight angle by an angle equal to or larger than a predetermined angle. That is, the correction unit 15 does not correct the line-of-sight angle when the deviation of the line-of-sight angle detected by the line-of-sight detection unit 13 from the reference line-of-sight angle is small.

In this manner, the correction unit 15 calculates the correction amount of the line-of-sight angle based on the reference line-of-sight angle and the line-of-sight angle detected by the line-of-sight detection unit 13 when the driver operates the start button B. The correction unit 15 corrects the line-of-sight angle detected by the line-of-sight detection unit 13 based on the calculated correction amount. For example, the correction unit 15 corrects the line-of-sight angle detected by the line-of-sight detection unit 13 when the driver recognizes the surroundings of the vehicle V based on the calculated correction amount. This allows the automatic parking system 1 to accurately acquire the line-of-sight angle of the driver during automatic parking after the start button B is operated.

Based on the line-of-sight angle detected by the line-of-sight detection unit 13, the visual recognition determination unit 16 determines whether the driver has visually recognized a region requiring visual recognition around the vehicle V after the automatic parking is started. The visual recognition determination unit 16 may determine that the region requiring visual recognition is visually recognized when the region has been visually recognized continuously for a predetermined time or more after the automatic parking is started. When the line-of-sight angle is corrected by the correction unit 15, the visual recognition determination unit 16 performs the above-described determination using the corrected line-of-sight angle.

Here, the region requiring visual recognition is a region where an obstacle (other vehicles, pedestrians, etc.) around the vehicle V should be checked. The region requiring visual recognition may include a region to be checked in automatic parking. In addition, the visual recognition determination unit 16 acquires the traveling direction in automatic parking from the driving execution unit 12. The visual recognition determination unit 16 may set the region requiring visual recognition so as to include the acquired region on the traveling direction side. For example, when the traveling direction in automatic parking is diagonally forward left, the visual recognition determination unit 16 sets the region requiring visual recognition so as to include the diagonally forward left region. The visual recognition determination unit 16 sets the region requiring visual recognition such that the region on the traveling direction side is included each time the traveling direction in automatic parking is changed.

The “predetermined time” used for determining whether the region requiring visual recognition is visually recognized may also be changed according to various situations. For example, the visual recognition determination unit 16 may set a predetermined time according to the circumstance of the surroundings of the vehicle V. For example, when there is an obstacle in or around the region requiring visual recognition, the driver needs to visually recognize the region requiring visual recognition more closely. Thus, for example, when there is an obstacle or the number of obstacles is large in or around the region requiring visual recognition, the visual recognition determination unit 16 may set the predetermined time to be longer than when there are no obstacles or the number of obstacles is small. For example, the visual recognition determination unit 16 may change the predetermined time according to the weather or brightness. For example, when it is raining, it is difficult to visually check the surroundings as compared with the case of fine weather. Thus, the visual recognition determination unit 16 may set the predetermined time longer when it is raining than when it is sunny. In addition, for example, when the surroundings are dark, it is difficult to visually check the surroundings as compared with a case where the surroundings are bright. Thus, the visual recognition determination unit 16 may set the predetermined time to be longer when the surroundings are dark than when the surroundings are bright.

When the visual recognition determination unit 16 determines that the region requiring visual recognition is not visually recognized, the notification unit 17 provides notification using the notification device 4. This notification is a notification for encouraging visual recognition of the region requiring visual recognition.

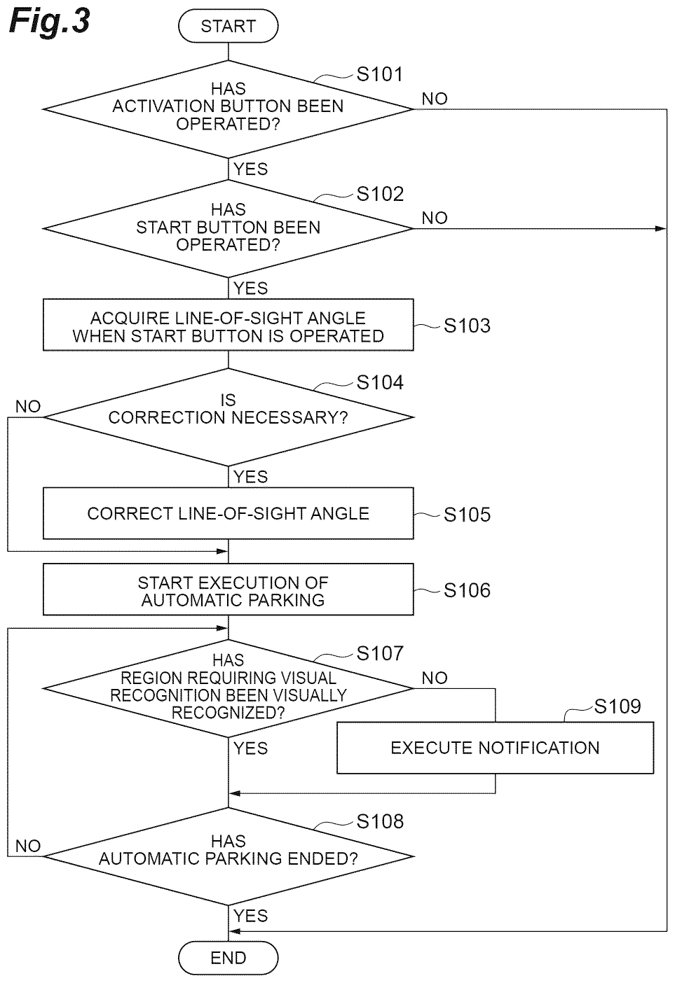

Next, a flow of processing when the automatic parking system 1 performs automatic parking of the vehicle V will be described. In the flowchart illustrated in FIG. 3, after the processing reaches END, the processing is started from START after a predetermined time. As illustrated in FIG. 3, the automatic parking system 1 determines whether the activation button for activating the automatic parking system 1 has been operated (S101). When the activation button has not been operated (S101: NO), the automatic parking system 1 starts the processing from START after a predetermined time. When the activation button has been operated (S101: YES), the display control unit 11 displays the start button B on the display screen 30. Then, the display control unit 11 determines whether the start button B has been operated (S102). Every time the activation button is operated to display the start button B, the display control unit 11 displays the start button B at a position different from the previous position. When the start button B has not been operated (S102: NO), the automatic parking system 1 starts the processing from START after a predetermined time.

When the start button B is operated (S102: YES), the correction unit 15 acquires the line-of-sight angle detected by the line-of-sight detection unit 13 when the driver operates the start button B (S103). The correction unit 15 determines whether it is necessary to correct the line-of-sight angle detected by the line-of-sight detection unit 13 (S104). Here, when the line-of-sight angle detected by the line-of-sight detection unit 13 when the driver operates the start button B deviates from the reference line-of-sight angle by an angle equal to or larger than a predetermined angle, the correction unit 15 determines that a correction is necessary. When no correction is necessary (S104: NO), the automatic parking system 1 performs the processing of S106.

When a correction is necessary (S104: YES), the correction unit 15 corrects the line-of-sight angle detected by the line-of-sight detection unit 13 (S105). Here, the correction unit 15 calculates the correction amount of the line-of-sight angle based on the reference line-of-sight angle and the line-of-sight angle detected by the line-of-sight detection unit 13 when the driver operates the start button B. The correction unit 15 corrects the line-of-sight angle detected by the line-of-sight detection unit 13 based on the calculated correction amount.

The correction unit 15 corrects the line-of-sight angle detected by the line-of-sight detection unit 13 using the correction amount calculated at the start of execution of the current automatic parking until the current automatic parking ends. That is, the correction unit 15 corrects the line-of-sight angle detected by the line-of-sight detection unit 13 when the driver is visually recognizing the surroundings of the vehicle V or the like after the start of automatic parking using the correction amount.

The driving execution unit 12 starts execution of automatic parking (S106). Based on the line-of-sight angle detected by the line-of-sight detection unit 13, the visual recognition determination unit 16 determines whether the driver has visually recognized the region requiring visual recognition around the vehicle V (S107). When the line-of-sight angle is corrected by the correction unit 15, the visual recognition determination unit 16 performs determination using the corrected line-of-sight angle.

When the driver is not visually recognizing the region requiring visual recognition (S107: NO), the notification unit 17 notifies the driver to visually recognize the region requiring visual recognition (S109). When the driver is visually recognizing the region requiring visual recognition (S107: YES) or after the notification of S109 is performed, the visual recognition determination unit 16 determines whether the automatic parking performed by the driving execution unit 12 has ended (S108). When the automatic parking has not ended (S108: NO), the visual recognition determination unit 16 performs the processing of S107 described above. When the automatic parking has ended (S108: YES), the automatic parking system 1 ends the processing of this time and starts the processing from START after a predetermined time.

In this manner, the automatic parking system 1 detects the line-of-sight angle of the driver and notifies the driver when the driver is not visually recognizing the region requiring visual recognition around the vehicle V. The automatic parking system 1 corrects the line-of-sight angle detected by the line-of-sight detection unit 13 based on the line-of-sight angle when the driver operates the start button B on the display screen 30. This allows the automatic parking system 1 to more accurately detect the line-of-sight angle of the driver and appropriately encourage the driver to visually check the surroundings of the vehicle V during automatic parking.

The visual recognition determination unit 16 sets the region requiring visual recognition so as to include a region on the traveling direction side of the vehicle V in automatic parking. The automatic parking system 1 provides notification when the region on the traveling direction side in automatic parking is not visually recognized. This allows the automatic parking system 1 to provide notification when a region requiring further visual check is not visually recognized when automatic parking is performed.

The visual recognition determination unit 16 determines that the region requiring visual recognition is visually recognized when the region has been visually recognized continuously for a predetermined time or more after the automatic parking is started. This allows the automatic parking system 1 to more appropriately determine whether the region requiring visual recognition is visually recognized.

When displaying the start button B on the display screen 30, the display control unit 11 displays the start button B at a position different from the previous position on the display screen 30. When the display position of the start button B is different every time, the driver needs to operate the start button B after confirming the position of the start button B. That is, the automatic parking system 1 can cause the driver to visually recognize the start button B more certainly when the start button B is operated. As a result, the automatic parking system 1 can acquire the line-of-sight angle when the start button B is visually recognized as the “line-of-sight angle when the driver operates the start button B” used when the line-of-sight angle is corrected. Thus, the automatic parking system 1 can more appropriately correct the line-of-sight angle.

The correction unit 15 estimates the line-of-sight angle when the start button B is visually recognized from the position of the head detected by the head detection unit 14, and use the estimated line-of-sight angle as the reference line-of-sight angle. This allows the automatic parking system 1 to correct the line-of-sight angle using a more appropriate reference line-of-sight angle in consideration of the actual height of the driver and the like.

Although an embodiment of the present disclosure has been described above, the present disclosure is not limited to the above embodiment. In the embodiment of the present disclosure, various modifications may be made.

What is claimed is:

1. An automatic parking system configured to perform automatic parking of a vehicle when a start button for instructing start of automatic parking is operated by a driver, the system comprising:
a display control unit configured to display the start button on a display screen of a touch panel;
a line-of-sight detection unit configured to detect a line-of-sight angle of the driver;
a visual recognition determination unit configured to determine whether a region requiring visual recognition around the vehicle is visually recognized after the automatic parking is started based on the line-of-sight angle detected by the line-of-sight detection unit;
a notification unit configured to provide notification when the visual recognition determination unit determines that the region requiring visual recognition is not visually recognized; and
a correction unit configured to correct the line-of-sight angle detected by the line-of-sight detection unit based on a reference line-of-sight angle determined based on a display position of the start button and the line-of-sight angle detected by the line-of-sight detection unit when the driver operates the start button on the display screen,
wherein the visual recognition determination unit is configured to perform the determination using the line-of-sight angle that has been corrected when the line-of-sight angle is corrected by the correction unit.

2. The automatic parking system according to claim 1, wherein the visual recognition determination unit is configured to acquire a traveling direction of the vehicle in the automatic parking and set the region requiring visual recognition such that a region on the traveling direction side that has been acquired is included.

3. The automatic parking system according to claim 1, wherein the visual recognition determination unit is configured to determine that the region requiring visual recognition is visually recognized when the region requiring visual recognition has been visually recognized continuously for a predetermined time or more after the automatic parking is started.

4. The automatic parking system according to claim 1, wherein the display control unit is configured to display the start button at a position different from a previous position on the display screen.

5. The automatic parking system according to claim 4, the system further comprising a head detection unit configured to detect a head position of the driver,
wherein the correction unit is configured to estimate a line-of-sight angle when the start button is visually recognized from the head position detected by the head detection unit and use the line-of-sight angle that has been estimated as the reference line-of-sight angle.
